(19) United States
(12) Patent Application Publication
(10) Pub. No.: US 2014/0376694 A1
(43) Pub. Date: Dec. 25, 2014

(54) SUBSTRATE MEASUREMENT APPARATUS AND SUBSTRATE MEASUREMENT METHOD

(71) Applicant: Kabushiki Kaisha Toshiba, Minato-ku (JP)

(72) Inventors: Hideaki ABE, Mie-gun (JP); Yasuhiko ISHIBASHI, Yokkaichi-shi (JP)

(73) Assignee: KABUSHIKI KAISHA TOSHIBA, Minato-ku (JP)

(21) Appl. No.: 14/021,030

(22) Filed: Sep. 9, 2013

Related U.S. Application Data
(60) Provisional application No. 61/837,368, filed on Jun. 20, 2013.

(51) Int. Cl. G01N 23/20; G01N 23/207

(52) U.S. Cl. CPC G01N 23/20008; G01N 23/207
USPC 378/71; 378/86

(57) ABSTRACT

In accordance with an embodiment, a substrate measurement apparatus circuit includes a light source, a detector, a data calculation unit, a mirror unit, a mirror drive unit, and a mirror drive calculation unit. The light source applies the electromagnetic waves to a measurement target substrate. The detector detects the electromagnetic waves diffracted or scattered by the application of the electromagnetic waves to the substrate. The data calculation unit processes a signal from the detector to acquire substrate information. The mirror unit includes a deflecting mirror which is adjusted to an optical condition where incident electromagnetic waves are totally reflected to control the track of the electromagnetic waves. The mirror drive unit drives the deflecting mirror in at least one of vertical, horizontal, and rotational directions. The mirror drive calculation unit calculates a drive amount to drive the deflecting mirror in at least one of the vertical, horizontal, and rotational directions.

### CROSS REFERENCE TO RELATED APPLICATIONS

This application is based upon and claims the benefit of U.S. provisional Application No. 61/837,368, filed on Jun. 20, 2013, the entire contents of which are incorporated herein by reference.

### FIELD

Embodiments described herein relate generally to a substrate measurement apparatus and a substrate measurement method.

### BACKGROUND

Along with the miniaturization of semiconductor integrated circuits, required specifications for measurement accuracy have been increasingly strict in the management of circuit pattern shapes. A microprobe is required to observe the shape of a micro circuit pattern, and an electron beam or light is used. Particularly, X-rays have an extremely short wavelength of 1 nm or less, and have been attracting attention as means of enabling accurate measurement of a miniaturized circuit pattern structure.

In connection with a measurement apparatus which uses X-rays to measure the pattern shape of a semiconductor circuit, X-ray reflectometry (hereinafter briefly referred to as “XRR”) and small angle X-ray scattering (hereinafter briefly referred to as “CD-SAXS”) are known.

The XRR is a method of measuring the thickness of a laminated membrane by simultaneously driving a light source and a detector at the same elevation angle and thereby capturing a change in X-ray reflection intensity with the elevation angle.

The SAXS is a shape measurement method of causing X-rays to enter a circuit pattern at an extremely small angle of 1° or less, detecting diffracted light corresponding to the shape of the circuit pattern by a detector, and reconstructing a sectional shape from an obtained scatter profile. In order to measure the sectional shape, it is necessary to apply X-rays at various incidence angles. Scattered light at various azimuths can be detected if, for example, a stage is rotated simultaneously with the application of X-rays.

For both the SAXS and the XRR, the measurement apparatus provided with a stage rotation drive mechanism or a goniometer drive mechanism is used to control the incidence angle and azimuth of the X-rays to the circuit pattern and thus detect information regarding the shape of the circuit pattern.

However, such a stage rotation mechanism or goniometer mechanism is provided with a large drive mechanism designed to have high angular resolution. The reduction of its drive time is difficult, and a long measurement time is required.

### BRIEF DESCRIPTION OF THE DRAWINGS

In the accompanying drawings:

FIG. 1 is a block diagram showing the general configuration of a substrate measurement apparatus according to Embodiment 1;

FIG. 2 is a top view showing the relationship between the path of X-rays and the direction of a pattern in the substrate measurement apparatus shown in FIG. 1;

FIG. 3A is a top view showing more detailed configurations of an X-ray tube and a mirror unit included in the substrate measurement apparatus shown in FIG. 1;

FIG. 3B is a diagram illustrating the operation of a mirror driver shown in FIG. 3A;

FIG. 4 is a diagram illustrating positional changes of deflecting mirrors with the change of an elevation angle;

FIG. 5 is a block diagram showing the general configuration of a substrate measurement apparatus according to Embodiment 2; and

FIG. 6 is a top view showing more detailed configurations of an X-ray tube and a mirror unit included in the substrate measurement apparatus shown in FIG. 5.

### DETAILED DESCRIPTION

In accordance with an embodiment, a substrate measurement apparatus circuit includes a light source, a detector, a data calculation unit, a mirror unit, a mirror drive unit, a mirror drive calculation unit, and a mirror drive control unit. The light source is configured to generate electromagnetic waves and apply the electromagnetic waves to a measurement target substrate. The detector is configured to detect the electromagnetic waves diffracted or scattered by the application of the electromagnetic waves to the substrate. The data calculation unit is configured to process a signal from the detector to acquire substrate information. The mirror unit includes a deflecting mirror which is adjusted to an optical condition where incident electromagnetic waves are totally reflected. The mirror unit is disposed between the light source and the substrate to control the track of the electromagnetic waves. The mirror drive unit is configured to drive the deflecting mirror in at least one of vertical, horizontal, and rotational directions during the application of the electromagnetic waves to the substrate. The mirror drive calculation unit is configured to calculate a drive amount to drive the deflecting mirror in at least one of the vertical, horizontal, and rotational directions so that the electromagnetic waves enter the substrate in a desired incidence direction. The mirror drive control unit is configured to control the mirror drive unit so that the deflecting mirror is driven in the calculated drive amount.

Hereinafter, several embodiments will be described with reference to the drawings. Like reference numerals are given to like parts in the drawings, and repeated explanations of these parts are appropriately omitted.

### (1) Embodiment 1

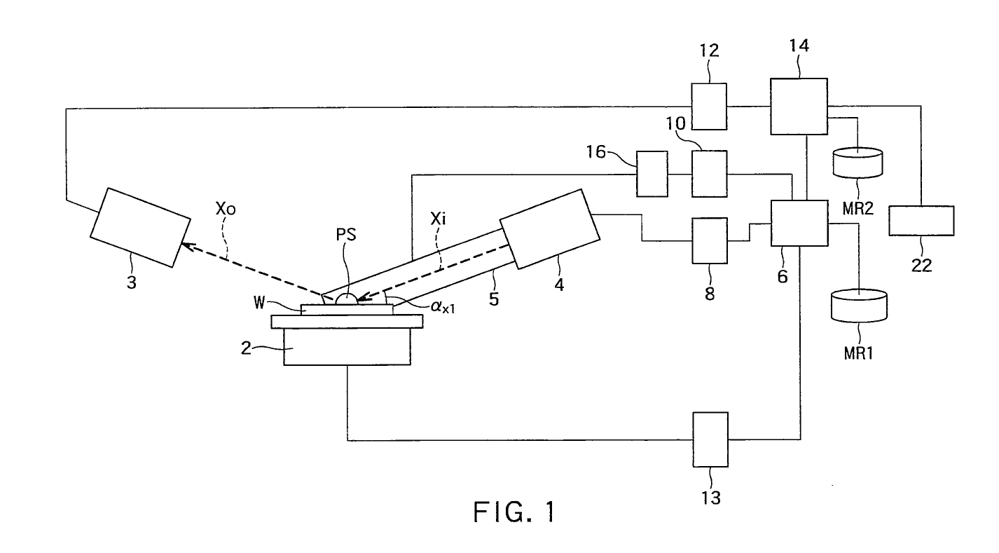

FIG. 1 is a block diagram showing the general configuration of a substrate measurement apparatus according to Embodiment 1. The substrate measurement apparatus according to the present embodiment is configured to be suitable for XRR measurement.

More specifically, the substrate measurement apparatus in FIG. 1 includes, as the main components, a stage 2, a stage controller 13, an X-ray tube 4, a light source controller 8, a mirror unit 5, a mirror drive calculator 10, a mirror drive controller 16, a two-dimensional detector 3, a data processor 12, a substrate information calculator 14, and a control computer 6.

The X-ray tube 4 is connected to the control computer 6 via the light source controller 8. The two-dimensional detector 3 is connected to the substrate information calculator 14 via the data processor 12. The substrate information calculator 14 is also connected to the control computer 6, a memory MR2, and a monitor 22.

A wafer W is mounted on the upper surface of the stage 2, and the stage 2 supports the wafer W. Receiving a control signal from the stage controller 13, the stage 2 moves the wafer W in an X-Y-Z three-dimensional space in accordance with an unshown actuator, and also rotates the wafer W by an arbitrary rotation angle.

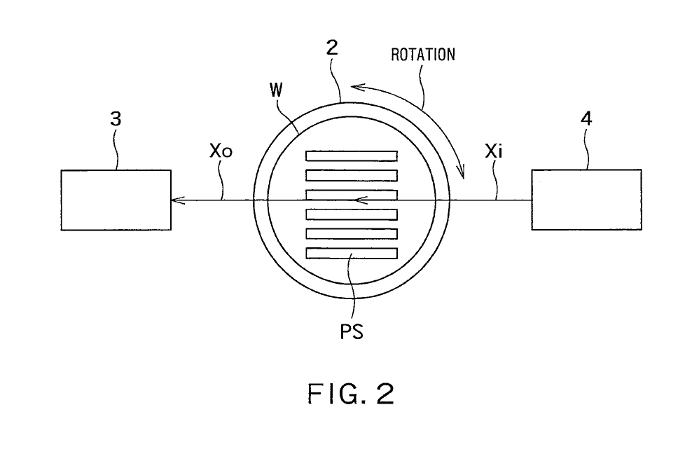

FIG. 2 is a top view showing the relationship between the path of X-rays and the direction of a pattern in association with the substrate measurement apparatus shown in FIG. 1. As shown in FIG. 2, a measurement target pattern PS having a periodic structure is formed on the surface of the wafer W. The periodic structure includes, for example, hole pattern structures arranged with a predetermined pitch in one direction or in two directions perpendicular to each other, or a structure in which a hole pattern and a line pattern are mixed, in addition to a line-and-space structure shown in FIG. 2. In the present embodiment, the wafer W corresponds to, for example, a substrate. The substrate includes, but not limited to the wafer W, for example, a glass substrate, a compound semiconductor substrate, and a ceramic substrate.

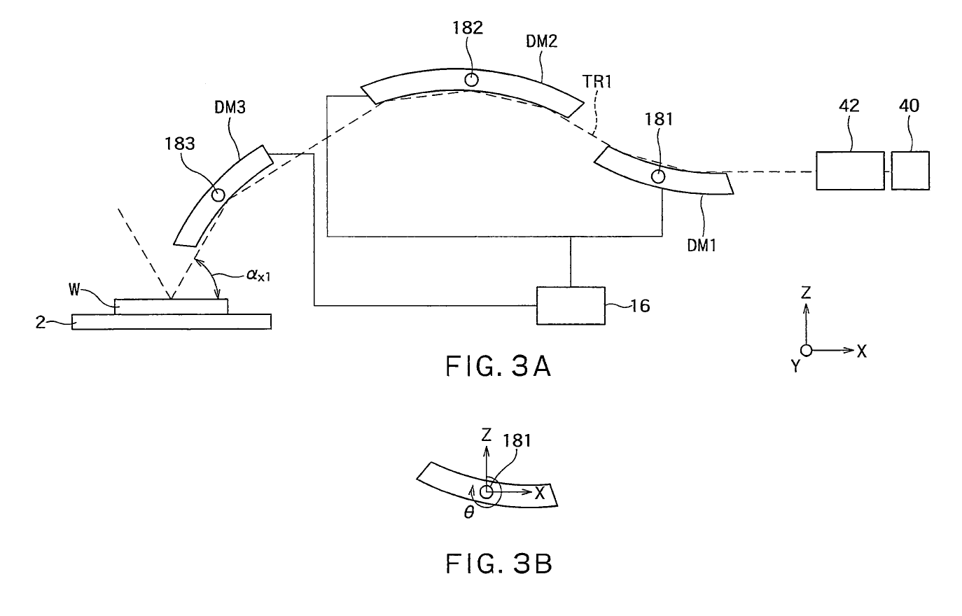

The X-ray tube 4 includes a light source 40 (see FIG. 3A) and a concave mirror (not shown), and generates X-rays having a wavelength of, for example, 1 nm or less. The light source 40 includes a light source which generates Ka-rays of Cu, but is not particularly limited as long as the light source generates X-rays.

More detailed configurations of the X-ray tube 4, the mirror unit 5, and mirror drivers 181 to 183 are shown in a top view of FIG. 3A. The X-ray tube 4 includes the light source 40 and a focus lens 42. X-rays Xi are generated in the X-ray tube in response to a control signal from the light source controller 8. The optical axis of the X-rays Xi is adjusted by the unshown concave mirror in the X-ray tube 4. The X-rays Xi are focused by the focus lens 42 so that the focal position of the X-rays Xi is adjusted. The X-rays Xi are then applied to the pattern PS at a desired elevation angle αx1 (see FIG. 1).

The mirror unit 5 includes deflecting mirrors DM1 to DM3. Each of these deflecting mirrors is a laminated mirror, and is designed and manufactured so as to have an optical condition that cause total reflection, i.e., to deflect the X-rays by total reflection. The deflecting mirrors DM1 to DM3 are concave mirrors having a small curvature. In the example shown in FIG. 3A, the deflecting mirror DM1 is disposed so that the concave surface of the deflecting mirror DM1 faces upward in a Z-direction which is a vertical direction, i.e., faces in a direction opposite to the wafer W. The deflecting mirrors DM2 and DM3 are disposed so that the concave surfaces of the deflecting mirrors DM2 and DM3 face downward in the Z-direction, i.e., faces toward the wafer W. Thus, the incident X-rays Xi repeat total reflection and at the same time travel on a track TR1, and then enter the wafer W at the elevation angle αx1. In this way, the mirror unit 5 deflects the X-rays by a plurality of deflecting mirrors so that the X-rays enter the pattern PS at a desired incidence angle.

The mirror drivers 181 to 183 are coupled to the deflecting mirrors DM1 to DM3, respectively. The mirror drivers 181 to 183 respectively include translational drive mechanisms which move the deflecting mirrors DM1 to DM3 in a horizontal direction (XY-direction) and a vertical direction (Z-direction), and rotational drive mechanisms which move the deflecting mirrors DM1 to DM3 in an arbitrary rotational direction with rotational axis in one of the X-direction, Y-direction, and Z-direction. The mirror drivers 181 to 183 are also connected to the mirror drive controller 16. Receiving a control signal, the mirror drivers 181 to 183 drive the deflecting mirrors DM1 to DM3 in one of the vertical, horizontal, and rotational directions before and during measurement, and thereby change the elevation angle αx1 of Xi entering the wafer W before and during measurement.

The mirror driver 181 is described by way of example. As shown in FIG. 3B, the mirror driver 181 moves the deflecting mirror DM1 in a given manner in a two-dimensional direction including the X-direction and the Z-direction, and also rotates the deflecting mirror DM1 at an arbitrary rotation angle θ. The relationship between the driving of the deflecting mirrors DM1 to DM3 by the mirror driver 181 and the track of the X-rays Xi will be described later in detail.

Back to FIG. 1, the two-dimensional detector 3 is located well apart from the pattern PS. The two-dimensional detector 3 detects, with light receiving elements, X-rays Xo reflected by the pattern PS to which the X-rays Xi have been applied, and the two-dimensional detector 3 measures the intensity of the X-rays Lo.

The light receiving elements are two-dimensionally arranged in the light receiving unit of the two-dimensional detector 3. Each of the light receiving elements measures the intensity of the X-rays Lo which have entered and then been reflected by the pattern PS while the elevation angle αx1 is changed by the mirror drive calculator 10, the mirror drive controller 16, and the mirror unit 5 within a predetermined measurement angular range of, for example, 0 degrees to 10 degrees at every predetermined angular interval. Each of the light receiving elements associates the measured intensity with its position, thereby creating a two-dimensional image of X-ray reflection intensity as the whole light receiving unit.

In the present embodiment, the data processor 12 adds up the scatter intensities measured by the light receiving elements of the two-dimensional detector 3, and thereby creates a reflectance profile.

When the periodic structure provided on the wafer W has laminated membranes, the X-rays are reflected by the surface of the wafer W and by the interface between membranes in the periodic structure and cause interference. If the intensity is plotted at every angular interval of the elevation angle αx1, interference fringes varying in intensity with angle are observed, and a reflectance profile is thus obtained. The reflectance profile including the interference fringes can be acquired by calculation from optical conditions and lamination information.

Here, the optical conditions include the wavelength and incidence angle (azimuthal direction, elevation angle direction) of the X-rays Xi entering the wafer W. The pattern information includes the sectional shape that means the edge portion of a surface pattern. The sectional shape is a function represented by shape parameters including the pitch, CD, height, wall angle, top rounding, and bottom rounding. The lamination information includes thickness, interface roughness, electron density. If a path difference is calculated from the wavelength and incidence angle of the X-rays and the distance between interfaces in the laminated membrane, a reflectance profile can be found by a simulation.

The substrate information calculator 14 is also connected to the data processor 12 and a memory MR2 in addition to the control computer 6. The memory MR2 stores a reflectance profile obtained by a simulation (hereinafter referred to as a “simulation reflectance profile”).

The substrate information calculator 14 receives the reflectance profile by actual measurement from the data processor 12, and on the other hand draws the simulation reflectance profile from the memory MR2. The substrate information calculator 14 checks the reflectance profile by actual measurement against the simulation reflectance profile, and performs fitting to minimize the difference therebetween. The substrate information calculator 14 outputs, as a measurement value of the surface shape of the pattern PS, the value of a shape parameter providing the minimum fitting error. In the present embodiment, the substrate information calculator 14 corresponds to, for example, a data calculation unit.

A previously found simulation reflectance profile may be taken into the memory MR2, or the substrate information calculator 14 may create a simulation reflectance profile.

A recipe file in which a series of procedures of the XRR measurement is described is stored in a memory MR1.

The control computer 6 reads the recipe file from the memory MR1, and generates various control signals and sends the control signals to the light source controller 8, the mirror drive calculator 10, the substrate information calculator 14, and the stage controller 13.

Receiving a control signal from the control computer 6, the mirror drive calculator 10 calculates the horizontal and vertical drive amounts and rotation amounts of the first to third deflecting mirrors DM1 to DM3 to change the elevation angle αx1 of the X-rays Xi in accordance with the XRR measurement procedures described in the recipe file. The mirror drive calculator 10 sends the calculation results to the mirror drive controller 16.

The mirror drive controller 16 generates a control signal so that the deflecting mirrors DM1 to DM3 are translationally driven and rotationally driven in accordance with the calculation results supplied from the mirror drive calculator 10. The mirror drive controller 16 then sends the control signal to the mirror drivers 181 to 183.

The mirror drivers 181 to 183 translationally drive and rotationally drive the deflecting mirrors DM1 to DM3 so that the deflecting mirrors DM1 to DM3 move and rotate in accordance with the control signal supplied from the mirror drive controller 16. The mirror drivers 181 to 183 thereby position the deflecting mirrors DM1 to DM3.

Here, two elevation angles within an elevation angle range during the XRR measurement are shown to describe in more detail the positioning of the deflecting mirrors DM1 to DM3 by the mirror drivers 181 to 183.

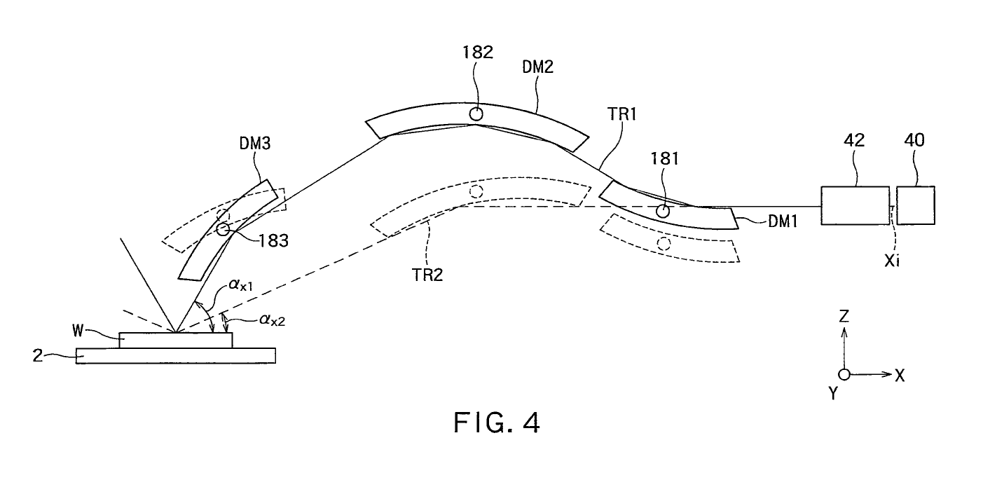

FIG. 4 is a diagram illustrating positional changes of the deflecting mirrors DM1 to DM3 in the case of the change of the elevation angle from αx1 to αx2(<αx1). In FIG. 4, the mirror drivers 181 to 183 and the X-ray track TR1 in the case of the X-rays Xi entering the wafer W at the elevation angle αx1 are indicated by solid lines, and the mirror drivers 181 to 183 and an X-ray track TR2 in the case of the X-rays Xi entering the wafer W at the elevation angle αx2 are indicated by dotted lines.

At the elevation angle αx1, the X-rays Xi emitted from the light source 40 travel while being totally reflected by the concave surfaces of the deflecting mirrors DM1 to DM3, and draw the same track TR1 shown in FIG. 3A and thus enter the wafer W.

At the elevation angle αx2, the deflecting mirror DM2 is moved downward in the Z-direction, i.e., toward the wafer W by the mirror driver 181 so that the X-rays Xi may not enter the deflecting mirror DM1. The deflecting mirror DM2 is adjusted by the mirror driver 182 so that the deflecting mirror DM2 is moved downward in the Z-direction and rotated counterclockwise to cause the X-rays Xi to enter the concave surface. Deflection by the deflecting mirror DM3 is not necessary. Therefore, the deflecting mirror DM3 is slightly moved downward in the Z-direction by the mirror driver 183, and on the other hand rotationally driven to rotate counterclockwise and thereby put out of the track TR2 of the X-rays Xi. In the present embodiment, the elevation angle αx1 corresponds to, for example, a first elevation angle, and the elevation angle αx2 corresponds to, for example, a second elevation angle.

### (2) Embodiment 2

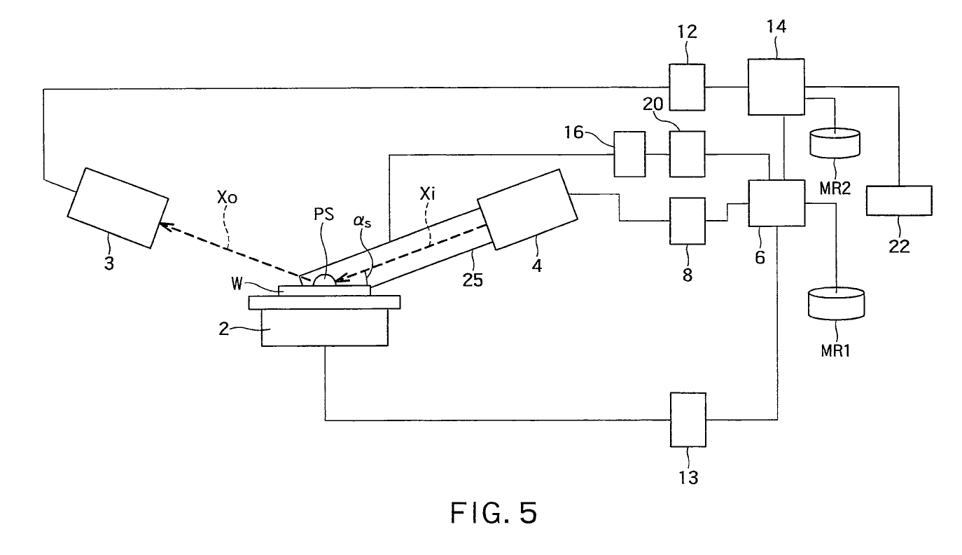

FIG. 5 is a block diagram showing the general configuration of a substrate measurement apparatus according to Embodiment 2. The substrate measurement apparatus according to the present embodiment is configured to be suitable for SAXS measurement.

As apparent from the comparison with FIG. 1, the substrate measurement apparatus according to the present embodiment includes a mirror unit 25 instead of the mirror unit 5 in FIG. 1, and includes a mirror drive calculator 20 instead of the mirror drive calculator 10 in FIG. 1. In the present embodiment, a series of procedures of the SAXS measurement is described in a recipe file stored in the memory MR1. A scatter profile obtained by a simulation (hereinafter referred to as a “simulation scatter profile”) is stored in the memory MR2.

The two-dimensional detector 3 is located well apart from the pattern PS. The two-dimensional detector 3 detects, with light receiving elements, X-rays Xo scattered by the pattern PS to which the X-rays Xi have been applied, and the two-dimensional detector 3 measures the intensity of the X-rays Xo.

In the present embodiment, the data processor 12 adds up the scatter intensities measured by the light receiving elements of the two-dimensional detector 3, and thereby creates a two-dimensional X-ray scatter profile. In other respects, the configuration of the substrate measurement apparatus according to the present embodiment is substantially the same as the configuration of the substrate measurement apparatus shown in FIG. 1.

In the CD-SAXS measurement, a taken scatter intensity image includes interference fringes which appear at an angle determined by Bragg's condition of diffraction in an azimuthal direction and an elevation angle direction. The data processor 12 divides the two-dimensional scatter intensity image in the azimuthal direction and the elevation angle direction, and calculates a scatter profile in each of the directions. Here, the profile in the azimuthal direction means a scatter profile in which the elevation angle of the incident X-rays Li is equal to the elevation angle of scattered X-rays Ls, and the profile in the elevation angle direction means the intensity change of diffraction peaks in the elevation angle direction.

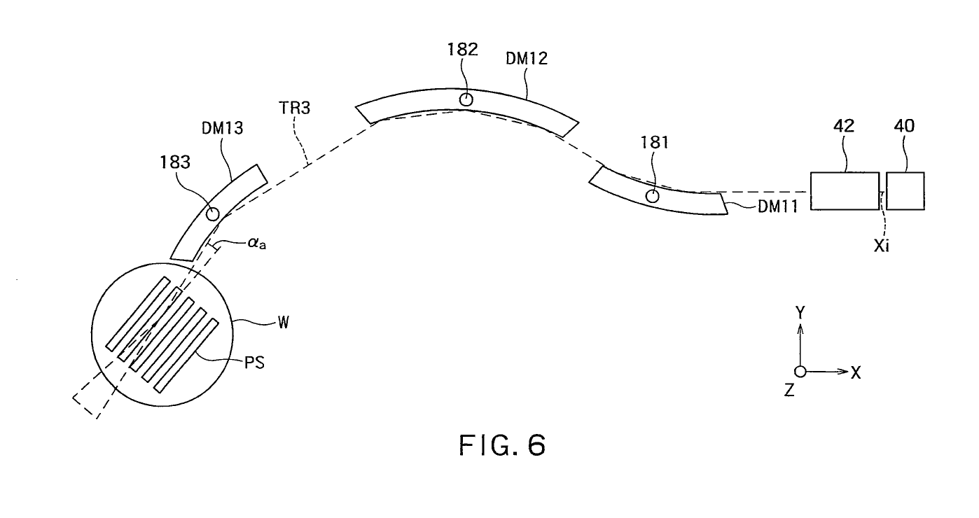

If the X-rays Li having an azimuth nearly parallel to the longitudinal direction of the line pattern and having an elevation angle of 1° or less, preferably, 0.2° or less are applied to the line pattern (see FIG. 6), the X-rays Li are scattered by the pattern. The scattered X-rays Ls cause interference, so that diffraction peaks appear in the scatter profile in the azimuthal direction, and an interference fringe appears in the elevation angle direction at each of the diffraction peaks.

The substrate information calculator 14 receives the scatter profile by actual measurement from the data processor 12, and on the other hand draws the simulation scatter profile from the memory MR2. The substrate information calculator 14 checks the scatter profile by actual measurement against the simulation scatter profile, and performs fitting to minimize the difference therebetween. The substrate information calculator 14 outputs, as a measurement value of the surface shape of the pattern PS, the value of a shape parameter providing the minimum fitting error. In the present embodiment, the substrate information calculator 14 corresponds to, for example, a data calculation unit.

The simulation scatter profile can be obtained by calculation from the optical conditions and pattern information.

More detailed configurations of the X-ray tube 4, the mirror unit 25, and the mirror drivers 181 to 183 are shown in a top view of FIG. 6. The X-ray tube 4 includes the light source 40 and the focus lens 42, as in Embodiment 1. X-rays Xi are generated in the X-ray tube 4 in response to a control signal from the light source controller 8. The optical axis of the X-rays Xi is adjusted by the unshown concave mirror in the X-ray tube 4. The X-rays Xi are focused by the focus lens 42 so that the focal position of the X-rays Xi is adjusted. The X-rays Xi are then applied to the pattern PS at a desired elevation angle αs (see FIG. 5).

As shown in FIG. 6, the mirror unit 25 according to the present embodiment includes deflecting mirrors DM11 to DM13 and the mirror drivers 181 to 183. As in Embodiment 1, each of the deflecting mirrors DM11 to DM13 is a laminated mirror which includes a concave mirror having a small curvature, and is designed and manufactured to deflect X-rays by total reflection.

The mirror drivers 181 to 183 are coupled to the deflecting mirrors DM11 to DM13, respectively. The mirror drivers 181 to 183 respectively include translational drive mechanisms which move the deflecting mirrors in a horizontal direction (XY-direction) and a vertical direction (Z-direction), and rotational drive mechanisms which move the deflecting mirrors in an arbitrary rotational direction with a rotation axis in one of the X-direction, Y-direction, and Z-direction. In this way, an azimuth αa of Xi entering the wafer W is changed not only before measurement but also during measurement.

In the example shown in FIG. 6, the deflecting mirror DM11 is disposed so that the concave surface of the deflecting mirror DM1 faces toward the positive side of the Y-direction in the horizontal direction, i.e., faces in a direction opposite to the two-dimensional detector 3. The deflecting mirrors DM12 and DM13 are disposed so that the concave surfaces of the deflecting mirrors DM12 and DM13 face toward the negative side of the Y-direction, i.e., face toward the wafer W. Thus, the incident X-rays Xi repeat total reflection and at the same time travel on a track TR3, and then enter the wafer W at the azimuth αa. In this way, the mirror unit 25 deflects the X-rays by a plurality of deflecting mirrors so that the X-rays enter the circuit pattern at a desired incidence angle.

While the substrate measurement apparatus suitable for the XRR measurement and the substrate measurement apparatus suitable for the SAXS measurement are described in the above embodiments, this is not a limitation. For example, a single substrate measurement apparatus can be configured to have both the XRR measurement function and the SAXS measurement function and suitably switch the functions in accordance with a mode change. In this case, the mirror driver may include a mechanism which can drive the mirror unit so that the X-ray track is controlled both in the elevation angle and the azimuth. A recipe file that enables both the XRR measurement and the SAXS measurement may be stored in the memory MR1. Both the simulation reflectance profile and the simulation scatter profile may be stored in the memory MR2. The control computer 6 may have a mode switch function.

According to at least one of the embodiments described above, the mirror drive unit and the mirror drive calculation unit are provided. The mirror drive unit drives the deflecting mirrors having the optical condition that cause total reflection in at least one of the vertical, horizontal, and rotational directions during the application of electromagnetic waves to the substrate. The mirror drive calculation unit calculates drive amounts to drive the deflecting mirrors in at least one of the vertical, horizontal, and rotational directions so that the electromagnetic waves enter the substrate in a desired incidence direction. Consequently, a desired X-ray incidence angle can be rapidly adjusted during measurement by use of the total reflection of X-rays even when there is no large driver.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A substrate measurement apparatus comprising:
a light source configured to generate electromagnetic waves and apply the electromagnetic waves to a measurement target substrate;
a detector configured to detect the electromagnetic waves diffracted or scattered by the application of the electromagnetic waves to the substrate;
a data calculation unit configured to process a signal from the detector to acquire substrate information;
a mirror unit comprising a deflecting mirror which is adjusted to an optical condition where incident electromagnetic waves are totally reflected, the mirror unit being disposed between the light source and the substrate to control the track of the electromagnetic waves;
a mirror drive unit configured to drive the deflecting mirror in at least one of vertical, horizontal, and rotational directions during the application of the electromagnetic waves to the substrate;
a mirror drive calculation unit configured to calculate a drive amount to drive the deflecting mirror in at least one of the vertical, horizontal, and rotational directions so that the electromagnetic waves enter the substrate in a desired incidence direction; and
a mirror drive control unit configured to control the mirror drive unit so that the deflecting mirror is driven in the calculated drive amount.

2. The apparatus of claim 1,
wherein the mirror unit comprises a plurality of deflecting mirrors.

3. The apparatus of claim 1,
wherein the mirror drive calculation unit calculates the drive amount so that the incidence direction of the electromagnetic waves forms an elevation angle to the substrate.

4. The apparatus of claim 3,
wherein the mirror unit comprises first to third deflecting mirrors arranged in order from the light source to the substrate, and
the mirror drive calculation unit calculates the drive amount so that the electromagnetic waves are reflected by the first to third deflecting mirrors and then enter the substrate at a first elevation angle and so that the electromagnetic waves are reflected by the second deflecting mirror and then enter the substrate at a second elevation angle lower than the first elevation angle.

5. The apparatus of claim 1,
wherein the mirror drive calculation unit calculates the drive amount so that the incidence direction of the electromagnetic waves forms an azimuth to the substrate.

6. The apparatus of claim 3,
wherein the mirror drive calculation unit further calculates the drive amount so that the incidence direction of the electromagnetic waves forms an azimuth to the substrate.

7. A substrate measurement method comprising:
generating electromagnetic waves and applying the electromagnetic waves to a measurement target substrate;
detecting the electromagnetic waves diffracted or scattered by the application of the electromagnetic waves to the substrate;
processing a signal from a detector to acquire substrate information; and
using a deflecting mirror to control the track of the electromagnetic waves between a light source and the substrate during the application of the electromagnetic waves to the substrate, the deflecting mirror being adjusted to an optical condition where incident electromagnetic waves are totally reflected,
wherein controlling the track comprises moving the deflecting mirror in at least one of vertical, horizontal, and rotational directions.

8. The method of claim 7, further comprising:
calculating a drive amount to drive the deflecting mirror in at least one of the vertical, horizontal, and rotational directions so that the electromagnetic waves enter the substrate in a desired incidence direction,
wherein the track is controlled by moving the deflecting mirror in accordance with the calculated drive amount.

9. The method of claim 8,
wherein the drive amount of the deflecting mirror is calculated so that the incidence direction of the electromagnetic waves forms an elevation angle to the substrate.

10. The method of claim 7,
wherein the drive amount of the deflecting mirror is calculated so that the incidence direction of the electromagnetic waves forms an azimuth to the substrate.
